(19) United States
(12) Patent Application Publication
(10) Pub. No.: US 2026/0200410 A1
(43) Pub. Date: Jul. 16, 2026

(54) VEHICLE ROOF TRAY ASSEMBLY (II)

(71) Applicant: AutoPacific Australia Pty Ltd., Keysborough (AU)

(72) Inventors: Wilhelm Gerard Schneider-Loos, Chelsea Heights (AU); Heshan Lakshika Baddevithana, Pakenham (AU); Benjamin Mark Bremner, Rosebud (AU)

(21) Appl. No.: 19/134,765

(22) PCT Filed: Dec. 1, 2023
(86) PCT No.: PCT/AU2023/051240

§ 371 Date: Jun. 2, 2025

(30) Foreign Application Priority Data
Dec. 2, 2022 (AU) 2022903678

(51) Int. Cl. B60R 9/045; B60R 9/048

(52) U.S. Cl. CPC B60R 9/045; B60R 9/048

(57) ABSTRACT

The present invention provides a vehicle roof tray assembly (2) comprising: perimetric frame members (4a, 4b, 4c) defining respective sides of the tray assembly, each frame member having a track (20) extending along a length thereof along which a tray attachment can be movably mounted; slats (8) extending between opposed sides of the tray assembly; and a connector (6) for interconnecting the frame members of two adjacent sides of the tray assembly, the connector having a slot (44) configured to, in use, merge with and interconnect the respective tracks (20) of the two adjacent frame members so as to permit: insertion of the tray attachment (34) into the slot (44) so that the tray attachment (34) can travel toward and along the adjacent tracks(20); and removal of the tray attachment (34) from the tray assembly via the slot (44).

### FIELD OF THE INVENTION

The present invention relates to a vehicle roof tray assembly.

### BACKGROUND OF THE INVENTION

Roof trays and assemblies thereof are routinely used to expand storage space and/or transport capacity of a motor vehicle. For example, a roof tray assembly may be used to store and/or transport large, bulky and/or unwieldy items such as, for example, ladders, scaffolds, luggage, packages, etc., as well as sporting goods (e.g., bicycles, kayaks, skis, or surfboards), camping gear, and/or vehicle accessories.

It is known to provide mounting accessories, also referred to herein as tray attachments, via which cargo can be secured (e.g., strapped) to the roof tray. Certain roof tray assemblies provide tracks along which these tray attachments can be movably secured. Given the wide range of items that might be expected to be carried by or secured to a roof tray, it is desirable to provide mounting tracks that can be used across a wide range of loading scenarios. However, only certain track segments provided with existing tray assemblies offer usable real estate, thereby limiting the manners in which the tray assembly can be securely loaded.

Conventionally, a roof tray assembly may be configured with a mounting structure that suits only one type or one category of cargo. That is, a particular roof tray assembly may not provide the ideal mounting structure or carrier for use with different types of cargo, thereby limiting its versatility and hence utility. It is commonly preferred that a roof tray assembly be able to accommodate different cargo items. Therefore, this deficiency has historically been addressed by affixing one or more mounting accessories to the roof tray assembly, where a given mounting accessory is adapted for use with a different cargo item.

This reliance on mounting accessories to provide versatility for a roof tray is, however, inherently problematic. Indeed, some changes or adaptations required to make a roof tray assembly compatible with a particular cargo may be impractical or even impossible from a manufacturing perspective. Additionally, mounting accessories are attached to roof racks using different mechanisms which are not universally compatible with roof tray assemblies. Therefore, a mounting accessory configured for use with a tray or roof rack from one manufacturer may prove incompatible with a tray or roof rack from another manufacturer.

There exists a need to overcome, or at least alleviate, one or more of the difficulties or deficiencies associated with the prior art. The present invention aims to substantially overcome or at least ameliorate one or more of the disadvantages of the prior art, or at least provide a commercial alternative to existing roof trays.

### SUMMARY OF THE INVENTION

According to a first aspect of the present invention, there is provided a vehicle roof tray assembly comprising:
perimetric frame members defining respective sides of the tray assembly, each frame member having a track extending along a length thereof along which a tray attachment can be movably mounted;
slats extending between opposed sides of the tray assembly; and
a connector for interconnecting the frame members of two adjacent sides of the tray assembly, the connector having a slot configured to, in use, merge with and interconnect the respective tracks of the two adjacent frame members so as to permit:
   insertion of the tray attachment into the slot so that the tray attachment can travel toward and along the adjacent tracks; and
   removal of the tray attachment from the tray assembly via the slot.

In embodiments of the assembly, the tracks are configured to receive the tray attachment for movement therealong, the tracks being configured to retain the attachment therein such that withdrawal of the attachment from the assembly is effected by moving the attachment along the tracks to the connector where the attachment can be withdrawn via the slot thereof.

The tray attachment may comprise an enlarged portion and each track may comprise a channel along the enlarged portion can slide. The tracks may also comprise a retaining ledge which, in use, obstructs the enlarged portion from being withdrawn from the tracks.

Preferably, a span of the slot is greater than that of the enlarged portion of the tray attachment so that the attachment can be inserted into and withdrawn from the slot.

In certain embodiments, the assembly is generally in the shape of a rectangle, the sides of which are defined by respective frame members, the corners of which are defined by respective connectors. When assembled, the tracks of the respective frame members and the slots of the respective connectors together define a generally closed and continuous track extending along a perimeter of the tray assembly, the slots defining locations where tray attachments can be added to or withdrawn from the continuous track.

In embodiments of the assembly, at least one frame member is configured to receive a light therein. The light may comprise an elongate light bar that extends along a length of the at least one frame member. The light bar may be secured to the respective frame member via known means. In a preferred embodiment the light bar may be secured to the respective frame member by one or more locking screws at any suitable point(s) along the frame member. In a further preferred embodiment the light bar may be secured to the frame member by one or more locking screws arranged at one or both ends of the light. For example, a light bar may be secured to the frame member by a screw at each end of the light bar which engages with the frame member to secure the light bar, thereby removing the need for screw access holes to be present in the front of the frame member.

It is envisaged that the slats and/or the frame members may comprise anchoring means for removably receiving hooks used in securing cargo to the tray assembly. For example, the anchoring means may comprise a longitudinally extending channel or ledge configured for receiving the hooks.

In this specification, the term ‘comprises’ and its variants are not intended to exclude the presence of other integers, components or steps.

In this specification, reference to any prior art in the specification is not and should not be taken as an acknowledgement or any form of suggestion that this prior art forms part of the common general knowledge in Australia or any other jurisdiction or that this prior art could reasonably be expected to be combined by a person skilled in the art.

The present invention will now be more fully described with reference to the accompanying examples and drawings. It should be understood, however, that the description following is illustrative only and should not be taken in any way as a restriction on the generality of the invention described above.

### BRIEF DESCRIPTION OF THE DRAWINGS/FIGURES

In order that the invention may be better understood and put into practical effect, reference will now be made to the accompanying drawings, in which:

FIG. 1 is a side perspective view of a vehicle roof tray assembly according to embodiments of the present invention;

FIG. 2A is a close-up top perspective view of a corner of the assembly of FIG. 1 prior to insertion of a tray attachment into a slot of a corner connector;

FIG. 2B is the view of FIG. 2A, showing the tray attachment received within a track of a frame member;

FIG. 3 is a cross-sectional end view of an example frame member of the assembly of FIG. 2A;

FIG. 4 is a top perspective view of a connector of the assembly of FIG. 1;

FIG. 5A is a close-up cross-sectional end perspective view of an example frame member and light bar received therein;

FIG. 5B is a cross-sectional end view of the frame member of FIG. 5A;

FIG. 5C is an alternate cross-sectional end view of the frame member of FIG. 5A;

FIG. 6A shows a cross-sectional perspective end view of a frame member and a slat of the present tray assembly cooperating with J-hooks; and

FIG. 6B is a cross-sectional perspective end view of the frame member of FIG. 6A cooperating with an S-hook.

### DETAILED DESCRIPTION OF THE EMBODIMENTS

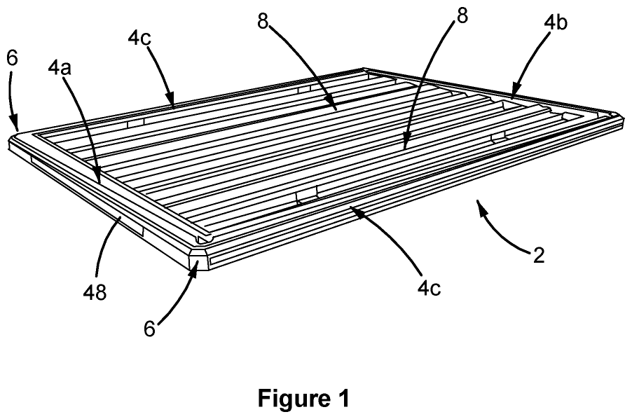

FIG. 1 shows a roof tray assembly 2 according to embodiments of the present invention. The assembly 2 is shown in an assembled state, and may also be referred to as a roof tray 2 in the present specification.

The roof tray assembly 2 comprises a perimetric frame 4 which generally defines an area upon which cargo can be loaded. In the depicted embodiment, the frame 4 is formed from four elongate frame members 4a to 4c interconnected together via four connectors 6 to form the general shape of a rectangle. In particular, there are two elongate front and rear members 4a, 4b and a pair of elongate side members 4c. Of course, in embodiments of the present assembly 2, certain elongate members 4 may be configured to connect with one another directly. For example, one frame member may be in the shape of U and thus define three of the four sides of the rectangular assembly 2; a second frame member would thus define the fourth side that closes the rectangle.

The assembly 2 also comprises a plurality of slats 8 extending within the perimeter defined by the frame members 4. The slats 8 are arranged parallel to one another and extend between opposed sides of the frame 4. In the depicted embodiment, the slats 8 extend between the front frame member 4a and the rear frame member 4b, though of course the slats 8 may instead extend between the two side frame members 4c. The frame members 4 and the slats 8 may be extruded from a material such as aluminium, though of course other manufacturing methods and materials are within the scope of the present specification. The assembled roof tray 2 can be connected to a crossbar of a roof rack (not shown) via known means to mount the tray 2 to the roof of a vehicle such as a car.

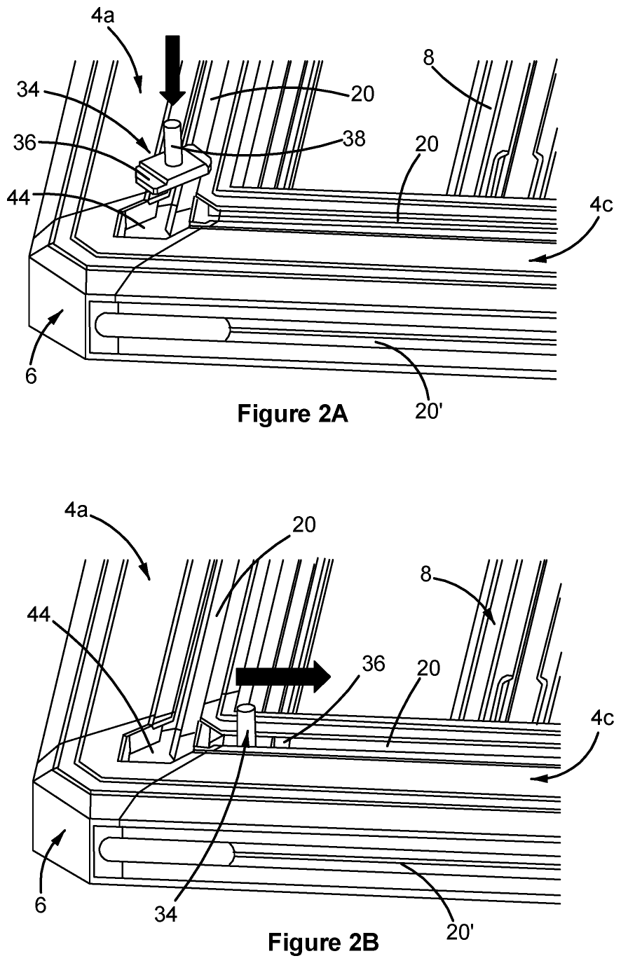

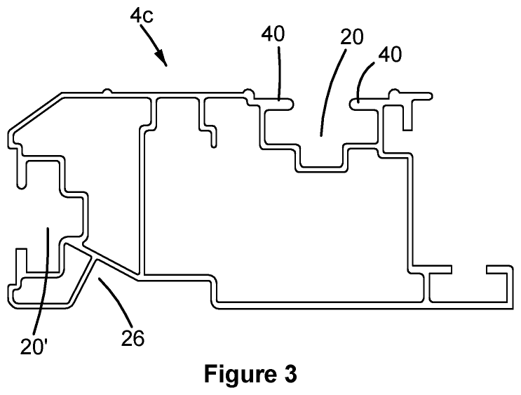

FIGS. 2A and 2B show a close-up top perspective view at a front corner of the rectangular assembly 2. An upper side of each of the frame members 4a to 4c comprises a track 20 extending along a length thereof. A tray accessory or attachment 34, such as that shown in FIG. 2A, is configured to be received within the track 20 (see FIG. 2B) so as to be slidable therealong. As such, the position of the tray attachment 34 can be adjusted along the length of the mounting tracks 20 to suit the loading scenario as needed.

The depicted tray attachment 34 comprises an enlarged base or portion 36 and an upwardly extending stem 38. The track 20 is configured to slidingly receive the enlarged portion 36 with the stem 20 protruding upwardly therefrom. Referring also to FIG. 3, the mounting tracks 20 of the frame members 4 comprise a longitudinally extending channel shaped and sized to receive the enlarged portion 36 of the tray attachment 34. In the depicted cross-sectional view of the frame member 4c, the walls defining the track 20 define a T-shaped slot in which the enlarged portion 36 of the attachment 34 can be slidingly received. Upper and inwardly extending horizontal walls of the T-shaped slot 20 define retaining ledges 40 that extend over an upper surface of the enlarged portion 36 of the tray attachment 34, thereby obstructing the attachment 34 from being vertically withdrawn from the track 20. In this way, the attachment 34 is slidable along a length of the track 20 but cannot be pulled upwardly so as to be withdrawn therefrom. The position of the tray attachment 34 can thus be selectively secured at various positions along the track 20 and is also prevented from being inadvertently withdrawn or otherwise removed from the tray assembly 2, which can be particularly important during transportation of cargo.

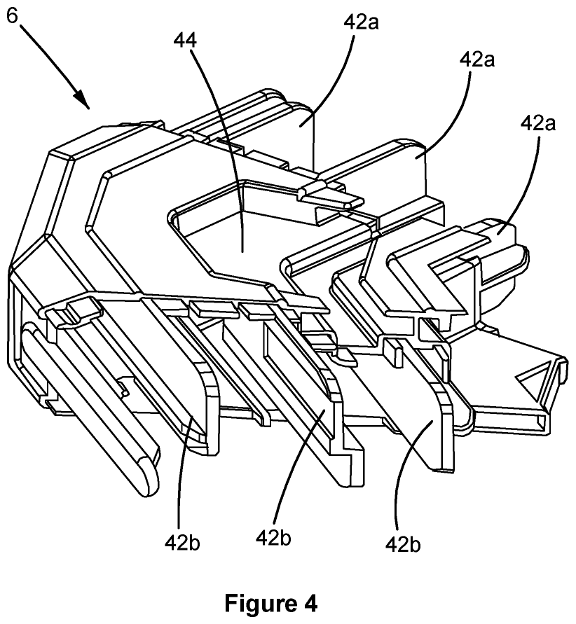

FIG. 4 shows a connector 6 of the present tray assembly 2. The connector 6 defines a corner of the tray assembly 2 and functions to interconnect the frame members 4 of adjacent sides of the tray assembly 2. In this regard, the depicted connector 6 comprises a first set of outwardly protruding fins or fingers 42a for insertion into one end of a first frame member, such as the rear frame member 4b, and a second set of fins or fingers 42b for insertion into one end of a second and adjacent frame member, such as side frame member 4c, thereby interconnecting the frame members 4 together and forming a corner of the rectangular assembly 2. Of course, other connection mechanisms and constructions for interconnecting the corner members 6 with the frame members 4 are within the scope of the present specification.

An upper side or face of the corner connector 6 comprises a recess or slot 44. Referring also to FIG. 2B, the slot 44 is configured and positioned such that, when assembled, the slot 44 merges with and interconnects the respective tracks 20 of the adjacent frame members 4a, 4c. In particular, the slot 44 is configured to function as an entry or exit point for tray attachments 34 to be added to and removed from the tray assembly 2, respectively. In this regard, a span of the slot 44 (e.g., a width and/or length dimension) is preferably slightly greater than that of the enlarged portion 36 of the tray attachment 34, thereby facilitating insertion and removal of the enlarged portion 36 relative to the slot 44 (see FIG. 2A). Once the enlarged portion 36 is inserted into the slot 44, the attachment 34 can then be moved toward an adjacent track 20 for travelling therealong (see FIG. 2B). As discussed, the attachment 34 is obstructed from removal from the tracks 20 by the retaining ledges 40 thereof. In this way, a substantial if not entire length of the tracks 20 can be utilised for the securement of tray attachments 34, while the corner connectors 6 allow for ready removal and insertion thereof. One or more frame members 4 may also comprise outward-facing longitudinal tracks 20′ via which tray attachments 34 can be slidably secured.

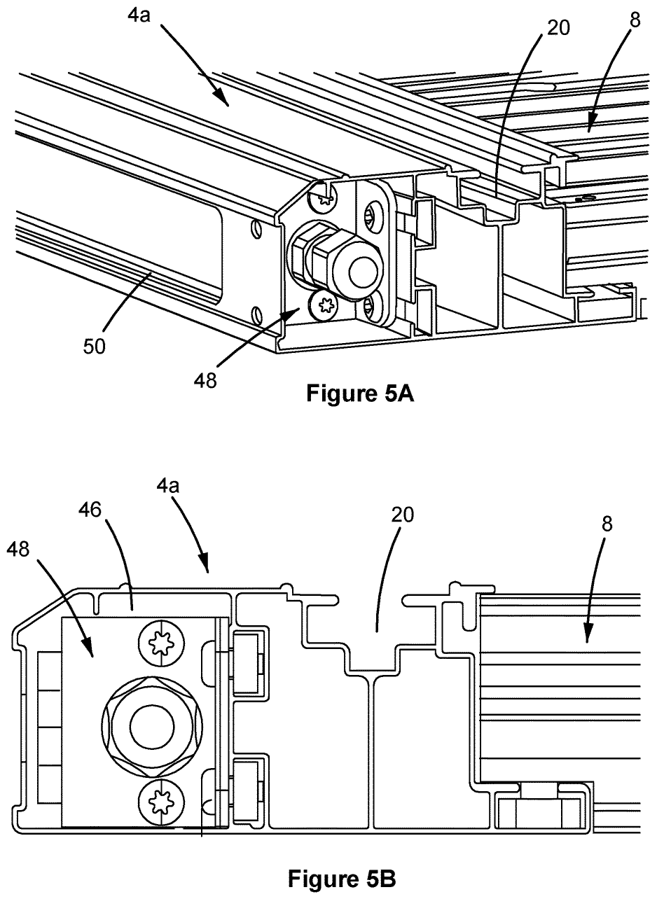

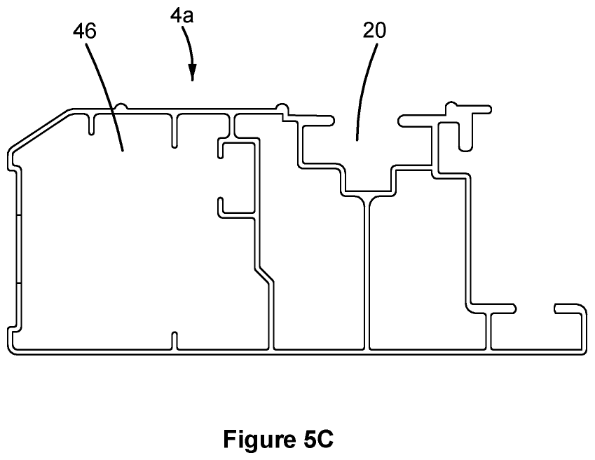

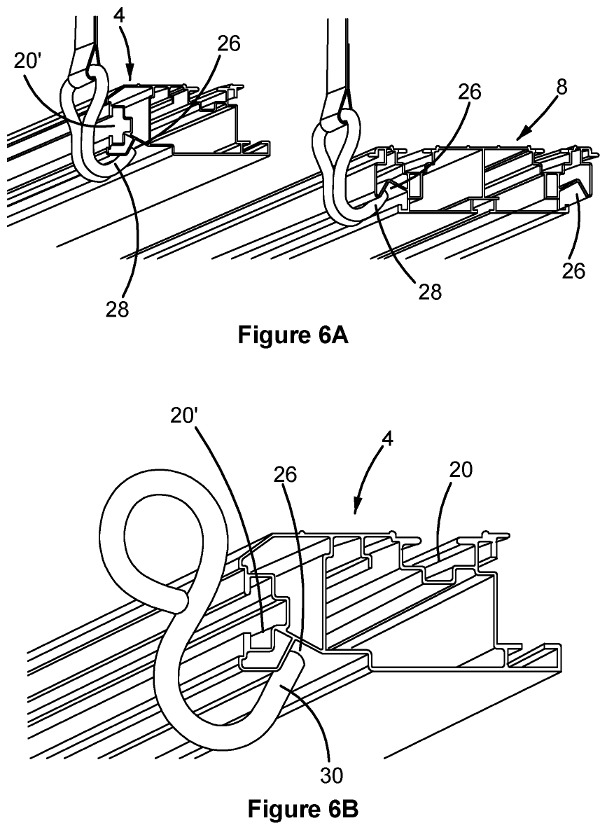

One or more frame members 4 may also be configured to receive a light, such as an elongate light bar 48. FIGS. 5A, 5B and 5C show a front frame member 4a having a different cross-sectional profile than that of FIG. 3. In particular, a forward portion of the frame 4a comprises an elongate housing or cavity 46 (see FIGS. 5B, and 5C absent the light bar 48) sized and shaped to snugly receive and substantially contain the light bar 48. A front side of the front frame member 4a is formed with an elongate opening 50 which may or may not be provided with a substantially transparent cover through which light from the light bar 48 can shine through. A rear of the light bar 48 may be secured to the frame member 4a via known means. For example, the rear of the light bar 48 may be secured to the frame member(s) 4/4a by a one or more locking screws. The light bar 48 may be inserted into the cavity 46 and secured therein before further assembly of the present roof tray assembly 2. By housing the light bar 48 within the longitudinally extending housing 46 of the front frame member 4a, the light bar 48 and its components are protected from the elements, as compared with externally provided light sources. It is envisaged that the position and/or angle of the light bar 48 may be manually adjusted, for example via access openings provided in an underside of the frame member 4a.

The slats 8 and frame members 4 are also formed with anchoring means via which components such as hooks and the like may be releasably fastened to strappingly secure cargo to the roof tray assembly 2. For example, with reference to FIGS. 4A and 4B, an underside of the frame 4 and slats 8 may be formed with one or more longitudinally extending ledges or channels 26 shaped to latchingly receive hooks, such as J-hooks 28 and S-hooks 30. Referring to FIGS. 3A and 3B, the walls of the channels 26 may resemble that of an upside-down V with inclined side walls, though other shapes which provide a ledge or surface which can be hooked is within the scope of the present specification.

Finally, it is to be understood that various alterations, modifications and/or additions may be made without departing from the spirit of the present invention as outlined herein.

1. A vehicle roof tray assembly comprising:
perimetric frame members defining respective sides of the tray assembly, each frame member having a track extending along a length thereof along which a tray attachment can be movably mounted;
slats extending between opposed sides of the tray assembly; and
a connector for interconnecting the frame members of two adjacent sides of the tray assembly, the connector having a slot configured to, in use, merge with and interconnect the respective tracks of the two adjacent frame members so as to permit:
insertion of the tray attachment into the slot so that the tray attachment can travel toward and along the adjacent tracks; and
removal of the tray attachment from the tray assembly via the slot.

2. The assembly of claim 1, wherein the tracks are configured to receive the tray attachment for movement therealong, the tracks being configured to retain the attachment therein such that withdrawal of the attachment from the assembly is effected by moving the attachment along the tracks to the connector where the attachment can be withdrawn via the slot thereof.

3. The assembly of claim 1, wherein the tray attachment comprises an enlarged portion and each track comprises a channel along the enlarged portion can slide, each track further comprising a retaining ledge which, in use, obstructs the enlarged portion from being withdrawn from the tracks.

4. The assembly of claim 3, wherein a span of the slot is greater than that of the enlarged portion of the tray attachment so that the attachment can be inserted into and withdrawn from the slot.

5. The assembly of claim 1 generally being in the shape of a rectangle, the sides of which are defined by respective frame members, the corners of which are defined by respective connectors.

6. The assembly of claim 5, wherein when assembled, the tracks of the respective frame members and the slots of the respective connectors together define a generally closed and continuous track extending along a perimeter of the tray assembly, the slots defining locations where tray attachments can be added to or withdrawn from the continuous track.

7. The assembly of claim 1, wherein at least one frame member is configured to receive a light therein.

8. The assembly of claim 7, wherein the light comprises an elongate light bar that extends along a length of the at least one frame member.

9. The assembly of claim 1, wherein the slats and/or the frame members comprise anchoring means for removably receiving hooks used in securing cargo to the tray assembly.

10. The assembly of claim 9, wherein the anchoring means comprise a longitudinally extending channel or ledge configured for receiving the hooks.
